(19) United States
(12) Patent Application Publication
(10) Pub. No.: US 2006/0254649 A1
(43) Pub. Date: Nov. 16, 2006

(54) Universal cradle for subterranean valve installations

(75) Inventors: James R. Cotugno, Baltimore, OH (US); Paul G. Bordner II, Baltimore, OH (US)

Correspondence Address: Diane E. Burke;Mueller and Smith, LPA, 7700 Rivers Edge Drive, Columbus, OH, 43235, US

(73) Assignee: James R. Cotugno

(21) Appl. No.: 11/432,641

(22) Filed: May 11, 2006

Related U.S. Application Data
(60) Provisional application No. 60/680,120, filed on May 12, 2005.

(51) Int. Cl. F16L 3/00

(52) U.S. Cl. 137/365

(57) ABSTRACT

A polymeric cradle having a base with a rectangular receiving surface emulating the surface of a brick. From the center of this receiving surface there extends a valve receptor of generally hexagonal cross section formed with oppositely disposed valve receiving mouths and generally oppositely disposed standards functioning to align the cradle within the saddle portion of a curb box and to align a valve stem of a valve supported at the mouths. The mouths are configured so as to permit universal utilization with a wide variety of valve configurations and sizes.

### CROSS-REFERENCE TO RELATED APPLICATIONS

This application claims the benefit of provisional Application No. 60/680,120, filed May 12, 2005, the disclosure of which is hereby incorporated by reference.

### STATEMENT REGARDING FEDERALLY SPONSORED RESEARCH

Not applicable.

### BACKGROUND OF THE INVENTION

Public water supplies as provided to metropolitan regions from municipal or private water service entities are distributed from a grid of mains and branches along rights or way or easements of user facilities. These distribution conduits are buried below ground surface at depths varying with the depths of average frost lines, main branch depths of three feet to four feet being common in the Midwest region of the United States.

Contracting entities connect these mains with residences or buildings from “curb stop” valves now typically using polymeric pipe. Thus, the valve-to-polymeric pipe connections are provided with compression fittings, the couplings being secured by tightening compression nuts located on the valves. The valves conventionally are configured for accommodating three quarter inch OD or one inch OD plastic pipe.

To afford above-ground surface access to the valves, the generally saddle configured-bell ends of elongate curb boxes are located over the valves in somewhat straddling fashion. These pipe-like structures typically are formed of cast iron and extend usually with an adjustable extension and lid to ground surface with the purpose of permitting valve actuation access from the surface. Support of the weight of the curb boxes typically is from a brick located beneath the valve against which the end of the saddle portion freely abuts. With this arrangement, access to turn the valves on or off is by an elongate valve actuating rod which is extended from ground surface through the curb box. These tools are configured with a key end called upon to engage the valve stem for rotational actuation. The curb box, brick and valve combination are assembled in an excavation, the elongate curb box being held in a vertical orientation as the excavation site is backfilled following the mounting of pipe to the valve.

Such water service installations have proven to be problematic. In the course of construction activity following their placement, the region of their location often will be subjected to construction off-road traffic. As this off-road traffic encounters relatively fresh backfill adjacent the curb boxes they will be forcefully displaced into a broad variety of orientations, a substantial number of which results in a valve-curb box alignment precluding access by the actuating rods. In this regard, a misalignment of as little as of 1½ inches can result in installation failure. The procedure for necessary repair is to dig out the backfill and vertically re-align the valve curb box, whereupon the repeated excavation again is backfilled. It is not uncommon for this corrective procedure to be carried out at about 50% of the service installations within about a three month interval following placement. The cost of such correction not only involves the labor of re-digging and re-backfilling, but also the cost associated with delayed water service as may be required during the final stages of building construction.

Proposals have been made to replace the supporting brick with a form of alignment cradle. The practicality of this approach has been impaired by virtue of the myriad of valve structures encountered in the field. A resulting myriad of cradle structures then are called for. These cradle structures proposed further are configured to evoke a relatively rigid physical union between the valve and the curb box. Such interconnection may, in itself, provoke an installation failure.

Similar curb box-based service installations have been provided in connection with the distribution of natural gas. For instance, some valves are configured with directionality features permitting their use either for water services or gas services. However, such gas service installations now are being supplanted by gas valving architectures which automatically turn off gas input on being disturbed and automatically turn on gas services as such time as the disturbance may be corrected.

### BRIEF SUMMARY OF THE INVENTION

The present invention is addressed to a universal cradle having a configuration lending its use to a significant variety of fluid valve configurations. Intended principally for use in water distribution from mains or branches into commercial buildings or homes, the cradle provides for a maintenance of acceptable curb-box-valve and valve stem relative orientations, allowing desired access to the valves with elongate turn-on and shut-off tools manipulated from terrain surface. Valves of given configuration typically are sold in two sizes, a large size intended for interconnecting 1 inch outside diameter (O.D.) pipe and a smaller size intended for interconnecting 0.75 inch O.D. pipe. Thus, the cradle provides improved support and alignment not only for different valve configurations, but also for different sizes of the valves having those configurations.

The cradle is configured with a base of rectangular periphery having a normally upwardly disposed receiving surface dimensioned to emulate the surface of a brick. Accordingly, field personnel will encounter an inherent familiarity with its use. Its length, extending along a medial base axis, is of sufficient extent to provide spaced apart smooth bearing surfaces located to freely abuttably receive and support the spaced apart box end surfaces of the saddle portion of a curb box. The base is light but rigid, the receiving surface being integrally formed with a reinforcing rib lattice or grid.

A valve receptor extends normally from the receiving surface at a location between the bearing surfaces. The receptor exhibits a generally hexagonal cross section internally and is configured with outwardly disposed upwardly extending reinforcing ribs which are mutually aligned such that when the cradle is installed within a curb box saddle; it is properly aligned as the outside surfaces of the ribs slide along the interior of the saddle portion. Two aligned and oppositely disposed mouths are provided in the valve receptor, which extend from its top to a location above the receiving surface to establish an internal cavity and oppositely disposed cradling ridges or edges. The mouths also establish two generally oppositely disposed upstanding standards which not only incorporate certain of the noted ribs but also function to align the stem portion of a valve carried between the two mouths. Certain of the smaller size valves are configured with very small stem portions and, thus, the cradle is supplied with annulus shaped polymeric and somewhat flexible shims which fit over the stem portions and are dimensioned to then engage each of the interior surfaces of each of the two standards. One particular larger size valve is configured with a downward extending protrusion having a large hexagonal component threaded thereto. To accommodate this singular large valve configuration, a hexagonal cavity is formed in the base opposite the receiving surface such that for this particular valve installation the cradle is turned upside down and the hexagonal component of the valve is inserted in the cavity.

The cradle is configured such that relative sliding motion is permitted between the curb box box end surfaces and the bearing surfaces of the cradle receiving surface. That relative rotative sliding is limited to a limit angle of about 300 through the utilization of oppositely disposed stop flanges extending normally upwardly from the longitudinal edges of the cradle receiving surface. The cradles may be configured as an integral unit of a polycarbonate polymeric material to provide a high degree of rigidity or from an ABS material where a certain amount of “give” or minor breakage may be considered beneficial to its use.

Other objects of the invention will, in part, be obvious and will, in part, appear hereinafter.

The invention, accordingly, comprises the apparatus possessing the construction, combination of elements and arrangement of parts which are exemplified in the following detailed disclosure. For a fuller understanding of the nature and objects of the invention reference should be had to the following detailed description taken in connection with the accompanying drawings.

### BRIEF DESCRIPTION OF THE DRAWINGS

FIG. 1 is perspective view of the assembly of a curb box with a curb stop valve and supporting brick as known in the prior art;

FIG. 2 is a partial cross section of a curb box saddle and curb stop valve displaced upon the upper surface of a brick as may be encountered with prior art procedures;

FIG. 3 is a sectional view taken through the plane 3-3 in FIG. 2;

FIG. 4 is a perspective view of one configuration of a valve which may be employed with the invention;

FIG. 5 is a perspective view of another configuration for a valve which may be employed with the invention;

FIG. 6 is a perspective view of another valve configuration which may be employed with the invention;

FIG. 7 is a perspective view of a curb stop valve installation similar to that shown in FIG. 1 but employing a cradle according to the invention;

FIG. 8 is a perspective view of a cradle according to the invention;

FIG. 9 is a front elevational view of the cradle shown in FIG. 8;

FIG. 10 is a side elevational view of the cradle shown in FIG. 8;

FIG. 11 is a top view of the cradle shown in FIG. 8;

FIG. 12 is a bottom view of the cradle shown in FIG. 8;

FIG. 13 is a partial perspective view of a curb box saddle portion and cradle according to the invention as associated with the valve configuration of FIG. 5;

FIG. 14 is a sectional view taken through the plane 14-14 shown in FIG. 13;

FIG. 15 is a sectional view taken through the plane 15-15 shown in FIG. 14;

FIG. 16 is a sectional view similar to FIG. 14 showing a cradle and curb box saddle portion associated with the valve illustrated in FIG. 4;

FIG. 17 is a sectional view taken through the plane 17-17 shown in FIG. 16;

FIG. 18 is a sectional view similar to FIG. 14 and showing the association of a curb box saddle portion with a cradle according to the invention and a larger size of the valve configuration shown in FIG. 6; and

FIG. 19 is a sectional view taken through the plane 19-19 shown in FIG. 18.

### DETAILED DESCRIPTION OF THE INVENTION

In the discourse to follow a typical curb stop valve installation utilizing a curb box in conjunction with a brick is described. Following that description typically encountered relative misalignment of the curb box and curb stop valve are illustrated. Next, the different shapes of curb stop valves are illustrated. As noted above, these shapes may be associated with larger valves, for instances, accommodating delivery pipe of one inch outside diameter (O. D) or smaller valves of the same general shape which accommodate ¾ inch O. D. delivery pipe. Notwithstanding having similar shapes, both the size and shape of these valves are accommodated by the universal cradle structure of the invention. Because of the universality which was achieved, suggested dimensions are presented as the description of the cradle unfolds.

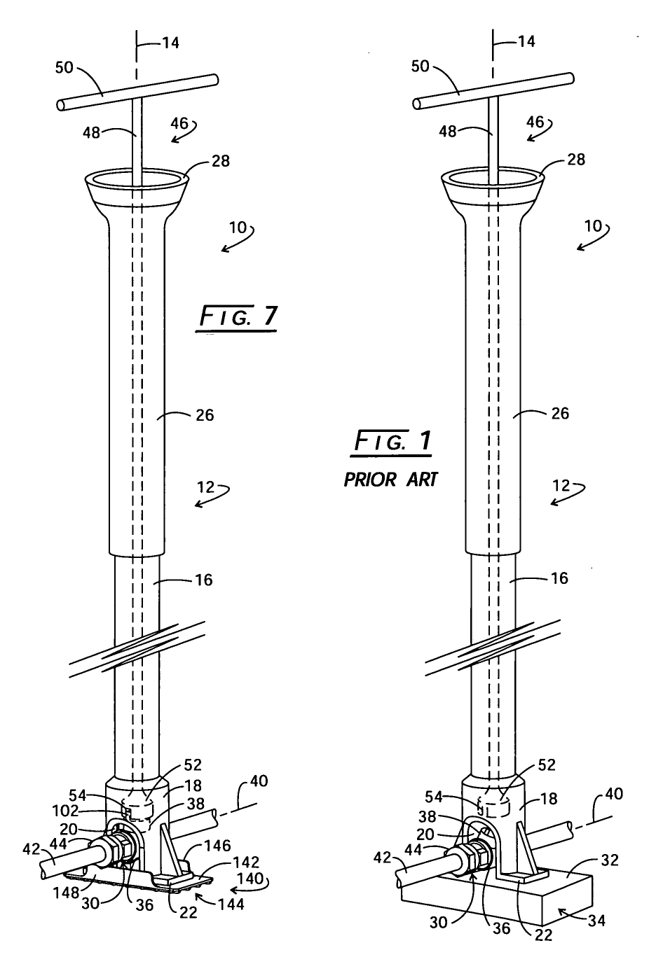

Referring to FIG. 1, a typical curb box and curb stop valve installation is represented generally at 10. Installation 10 incorporates a two component curb box represented generally at 12 which is a pipe-like structure having an open interior disposed about a box axis 14. The lower component 16 of box 12 extends to a lower disposed saddle portion 18 with a transverse opening 20 extending through it. Saddle portion 18 extends about the transverse opening 20 to provide oppositely disposed spaced apart box end surfaces, one of which is seen at 22. The upper end of lower component 16 generally is threaded with widely spaced threads which function to threadably engage the interior of curb box upper component 26. Component 26 extends upwardly to ground surface at an annular opening 28 which is normally covered and uncovered for access to a subterranean valve. That curb stop valve is represented generally at 30 resting upon the upper surface 32 of a brick represented generally at 34. Transverse opening 20 of saddle portion 18 of the curb box lower component 16 is seen to straddle valve 30. In this regard, each of the box end surfaces, one of which is shown at 22, engages the upper surface 32 of brick 34. Valve 30 is configured with a centrally disposed base portion 36 from which upwardly extends a stem portion 38 which is, in turn, configured with an upwardly extending key which is rotatable to open or close the valve. Valve 30 is shown with a valve axis 40 and a delivery pipe is seen at 42 having been coupled with a compression fitting 44 of the valve. Valve 30 is turned off and on from the terrestrial surface utilizing an elongate tool represented generally at 46. Tool 46 is configured with an elongate rod 48 coupled at its uppermost end with a transverse crank handle 50 and extending downwardly to a slotted rod keyway 52. To actuate valve 30 on and off, that slot or keyway must engage the corresponding valve key of stem portion 38. Note in the instant demonstration that the valve 30 stem is not vertically aligned with the rod 48 and associated rod keyway 52. This poses difficulties in actuating the valve 30 if not impossibilities requiring a reinstallation of the system of curb box and curb stop valve. The skewed geometry is one of relative movement between the valve 30 and the associated curb box 12 as well as brick 34.

Field installation personnel encounter a variety of failures of alignment between the curb box and curb stop valve. Very often this misalignment is a result of surface compression due to movement of the curb box both angularly and laterally. Thus, the misalignment being referred to herein may be considered to be a result of relative movement between valve and curb box. In the figures to follow, components of the curb box continue to be described in conjunction with the identifying numeration set forth in FIG. 1. A different shaped valve is shown in FIG. 2 as represented in general at 60. Valve 60 is shown having a valve axis 62 along with a valve base portion, 64, and compression nut fittings 66 and 68 oppositely disposed and spaced apart along the axis 62. A generally centrally disposed stem portion is shown at 70 extending upwardly to an upwardly extending valve key 72. Note that the valve 60 also is configured with a protrusion 74 which depends downwardly from the base portion 64. The bottom surface of protrusion 74 is seen engaged with the upper surface 32 of brick 34 and relative movement between valve 60 and the saddle portion 18 of the curb box has resulted in an association between valve and saddle portion wherein stem portion 70 has shifted laterally from left to right in the sense of the figure. This poses difficulties if not impossibilities for engagement of the rod keyway 52 with the valve key 72.

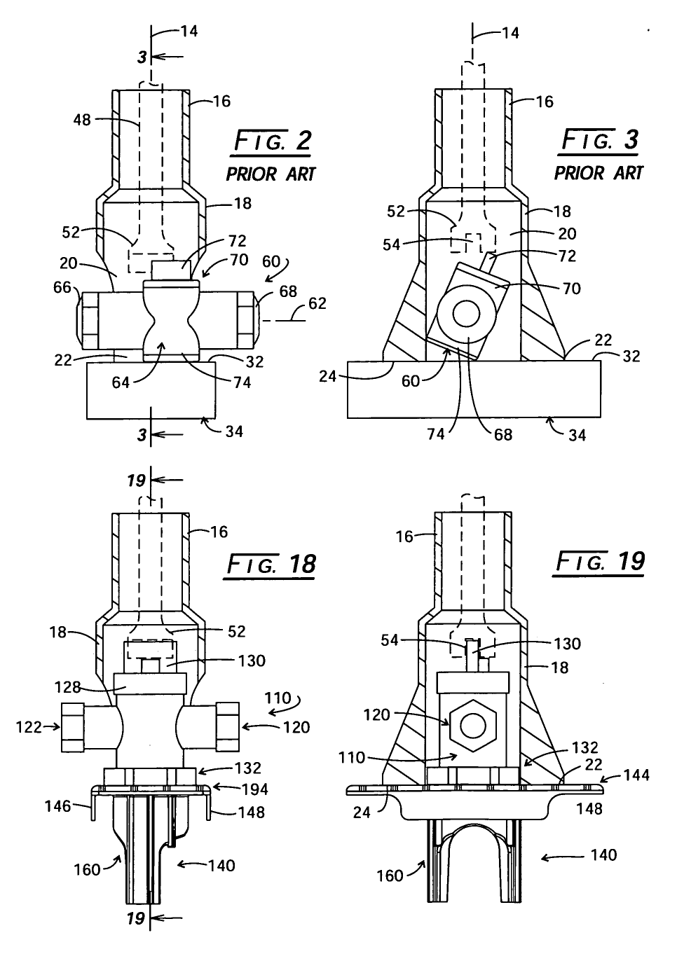

Looking to the sectional view of FIG. 3 the valve 60 is seen not only to have relatively shifted laterally, but also to have relatively rotated about its axis 62. That rotation, as noted above may be manifested by the movement of the curb box 12 and its compressibly associated supporting brick 34. The geometric relationship between rod keyway 52 and valve key 72 illustrates a second level of difficulty carrying out any remote actuation of valve 60. Returning momentarily to FIG. 1, it may be observed that valve 30 is shown with a relative rotation about its axis 40. The figure also identifies both box end surfaces 22 and 24.

Now considering the shape and proportion of the valves, reference is made to FIGS. 4, 5 and 6 showing the shapes of three typically encountered valves. As noted above, these valves may be relatively larger being sized to accommodate one inch O. D, pipe or may be smaller in proportion when utilized with 0.75 inch O.D. pipe. Valve 60 reappears in FIG. 4. In the figure, it may be observed that base portion 64 is configured with oppositely disposed coaxially arranged extensions 76 and 78. The outer surfaces of these extensions 76 and 78 exhibit the same diameter, i.e., the base is symmetrical extending to each compression fitting. The compression fittings 66 and 68 are seen to be configured with respective compression nuts 80 and 82. Note, additionally, that the downwardly depending protrusion 74 is of generally cylindrical shape and extends to a protrusion end surface 84. The cradle of the invention is called upon to accommodate for the downward protrusion 74 while maintaining an alignment of stem portion 70 with the box axis 14 (FIGS. 1-3). Additionally, the cradle must permit field personnel access to the compression nuts 80 and 82 permitting their loosening and tightening without cradle interference. Those support criteria must be available for both a large valve size suited for 1 inch O.D. pipe and smaller valve proportioning suited for 0.75 inch O.D. pipe.

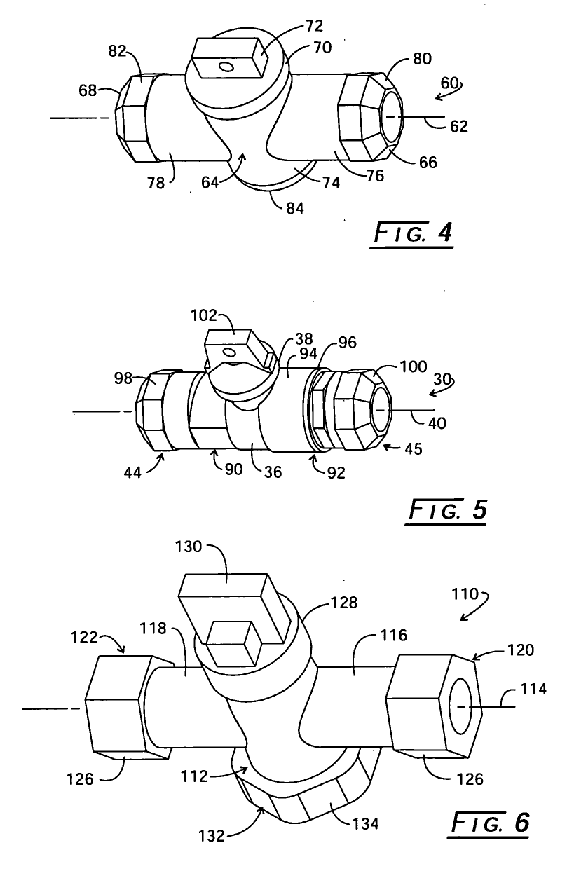

Looking to FIG. 5, valve 30 reappears, again being represented numerically identified in general at 30. As before, valve 30 is configured with a base portion 36 disposed symmetrically about value axis 40. From that base portion, a stem portion 38 extends upwardly and perpendicularly to axis 40. Note, that there is no protrusion extending from base 36 as earlier described at 74 in connection with valve 60. The base portion 36 is configured with oppositely disposed base portion extensions represented generally at 90 and 92. It may be noted, however, that the surface configuration of extension 90 is different than that of extension 92. Extension 92 exhibit a surface having what may be considered a diametric extent which is larger than that of extension 90. Only portions of the external surface of extension 90 are of generally cylindrical curvature and the surface configuration of extension 92 is quite different from that of extension 90. In this regard, the extension 92 exhibits a cylindrical surface at 94 which transitions into a generally hexagonal peripheral configuration at 96. In effect, extensions 90 and 92 may be considered asymmetrical. Valve 30 is configured with compression fittings 44 and 45 which include respective compression nuts 98 and 100. Stem portion 38 is seen to extend to a valve key 102 intended for engagement with rod keyway 54 of rod 46 (FIGS. 1 and 3).

Looking to FIG. 6, another valve structure is represented generally at 110. Valve 110 incorporates a base portion which is disposed about a valve axis 114. Base portion 112 is configured with generally cylindrical extensions 116 and 118 which support oppositely disposed respective compression fittings represented generally at 120 and 122. Fittings 120 and 122 are configured with respective compression nuts 124 and 126. Extending upwardly from base portion 112 is a stem portion 128 having an upwardly depending valve key 130. Valve 110 further is configured with a protrusion represented generally at 132 which incorporates a threadably attached protrusion component of generally hexagonal-shaped periphery as shown at 134. Where valve 116 is configured in lager proportion suited for 1 inch O.D. pipe attachment, the hexagonal component is quite large, for example, the distance between parallel surfaces of the hexagon being about 2½ inches. By contrast, the corresponding dimension for a valve 110 configured for attachment with 0.75 inch O. D. pipe is about 2⅛ inch.

Referring to FIG. 7 and revisiting installation 10, valve 30 now is seen to be supported by a cradle configured according to the invention and represented generally at 140. Box end surface 22 is in freely abutting adjacency with one of two oppositely disposed bearing surfaces of the normally upwardly disposed receiving surface 142 of a cradle base represented generally at 144. Cradle 140 supports valve 30 in a manner wherein its stem portion as at 38 is generally aligned with axis 14. Accordingly, the keyway 54 of rod key 52 is readily asserted over the valve key 102 of valve 30. Base portion 36 or any extensions of such base portions will be seen to be supported by the cradle 140 which is slidably aligned within curb box lower component 16 saddle portion 18. In general, the receiving surface 142 of the cradle 140 is dimensioned and configured to emulate the corresponding upper surface 32 of a brick 34 as described in connection with FIG. 1. Surface 142 which is normally upwardly disposed is smooth such that should the curb box lower portion 16 be subject to relative rotation about axis 14, box end surfaces as at 22 will slide but the amount of such rotative sliding is limited by stop flanges as at 146 and 148 which extend upwardly from surface 142. The extent of such permitted relative rotation is about 30°.

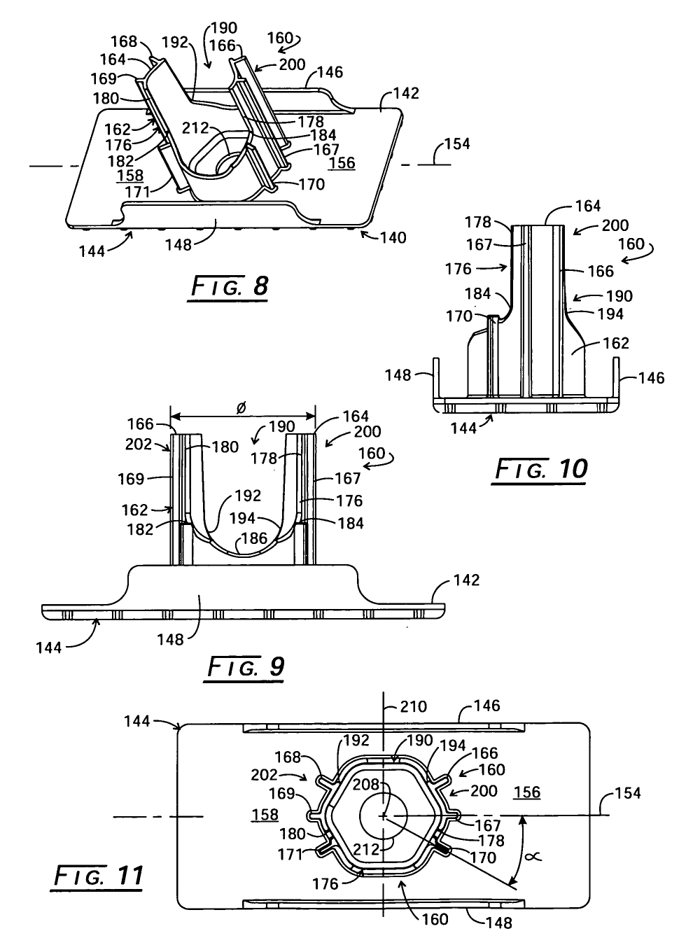

Looking to FIG. 8, a perspective view of the cradle 140 is presented. In the figure, the receiving surface 142 reappears at the top of base 144. Additionally, stop flanges 146 and 148 are seen located along the longitudinal peripheries of base 144. Base 144 extends along a longitudinal base axis 154 and exhibits a length along that axis of about 8.75 inches which is effective to receive the saddle portion 18 spaced apart box end surfaces 22 and 24 (FIG. 3) at corresponding oppositely disposed bearing surfaces represented generally at 156 and 158. The width of base 144 is about 4.0 inches. Fixed to and extending generally normally from the base receiving surface 142 at a location between bearing surfaces 156 and 158 is a valve receptor represented generally at 160. Receptor 160 is configured with an upstanding receptor wall represented generally at 162. Wall 162 has a maximum length extending from the receiving surface 142 of base 144 to a top or maximum top surface 164. Receptor wall 162 is reinforced with four externally disposed elongate ribs 166-169 and two shorter ribs 170 and 171. Wall 162 and its associated ribs 166 171 exhibit a cross section having a maximum dimension extending between the outer surfaces of oppositely disposed ribs as seen in FIG. 10 of about 3.15 inches. This dimensioning as revealed in connection with FIG. 11 is provided between oppositely disposed ribs 167 and 169; 168 and 170; and 166 and 171. The dimension permits slidable insertion within the transverse opening of saddle portion 18 as illustrated in connection with FIG. 7. However, as noted above, relative rotation between bearing surfaces 156 and 158 and the box end surfaces 22 and 24 continues to be available.

Receptor 162 is configured with two oppositely disposed supportive mouths, a first and relatively larger one being represented generally at 176. Mouth 176 is arranged generally perpendicular to and symmetrically disposed transversely to base axis 154. It exhibits a mouth width between receptor wall edges 178 and 180 of about 2.375 inches. As seen in FIG. 9, that width extends from the top 164 to the commencement of oppositely disposed mutually converging ridges 182 and 184 as seen in FIG. 9. Ridges 182 and 184 generally arcuately converge to a middle portion spaced above surface 142 to define a lower ridge structure and form a receiving cavity. At the lowermost central portion of the ridge defined between ridge components 182 and 184 is a relatively smaller arc edge seen in FIG. 9 at 186. This small central arc edge region exhibits a radius of about 0.850 inches. Aligned with the generally U-shaped mouth 176 transversely to the longitudinal axis 154 is the second generally U-shaped mouth represented generally at 190. Mouth 190 is located further outwardly from central axis 154 than mouth 176 and thus, its principal widthwise dimension is less than that of mouth 176. Mouth 190 extends having a maximum widthwise dimension from top 164 to the commencement of a ridge with commencement portions seen in FIG. 9 at 192 and 194 of about 1.875 inches. The ridge defined between commencement regions 192 and 194 is generally arcuate exhibiting a radius generally commensurate with the radius of arcuate component 186 of mouth 176. In general, the bottom of the arcuate edge portion 186 is aligned with the bottom of mouth 190 along an axis parallel to surface 142.

With the geometrical arrangement shown U-shaped mouths 176 and 190 cooperate to define relatively elongate upstanding standards represented generally at 200 and 202. These standards are seen additionally in FIGS. 9 and 11, while standard 200 is seen in FIG. 10. FIG. 10 also illustrates the transversely offset position of mouth 190 with respect to the centrally disposed base axis 154.

Looking to FIG. 11, it may be observed that valve receptor 160 is symmetrically disposed about the center point 208 defined between centrally disposed longitudinal axis 154 and center axis 210 of the base 144. Its internal surfaces define a cavity which is generally hexagonal in configuration and the distance between oppositely disposed parallel internal surface components of that cavity is about 2.25 inches. A drainage aperture 212 is symmetrically disposed about the center point 208 and extends through the base 144.

Looking to FIG. 12 the side of base 144 opposite the bottom of receiving surface 142 is revealed. This bottom side as represented in general at 216 is configured with a reinforcing grid extending outwardly from the bottom 218 of receiving surface 142. Portions of that grid are identified at 220 and the outward surfaces of each of the ribs of the grid are coplanar and parallel with surface 218. As a consequence, these ribs may be employed as an alternative to bearing surfaces 156 and 158 (FIG. 11). Accordingly, such corresponding bearing surfaces are shown generally in FIG. 12 at respective locations 222 and 224. These rib edge defined surfaces extend about 0.38 inches outwardly from the surface 218.

Note in FIG. 12 that centrally disposed within the base bottom side is a generally hexagonally-shaped valve base receiving cavity 226. Parallel opposite sides of the interior of cavity 226 are spaced apart about 2.625 inches, a spacing adequate to slidably receive the hexagonal component 134 of valve 110 when configured in its larger size intended for connection with 1 inch O. D. pipe.

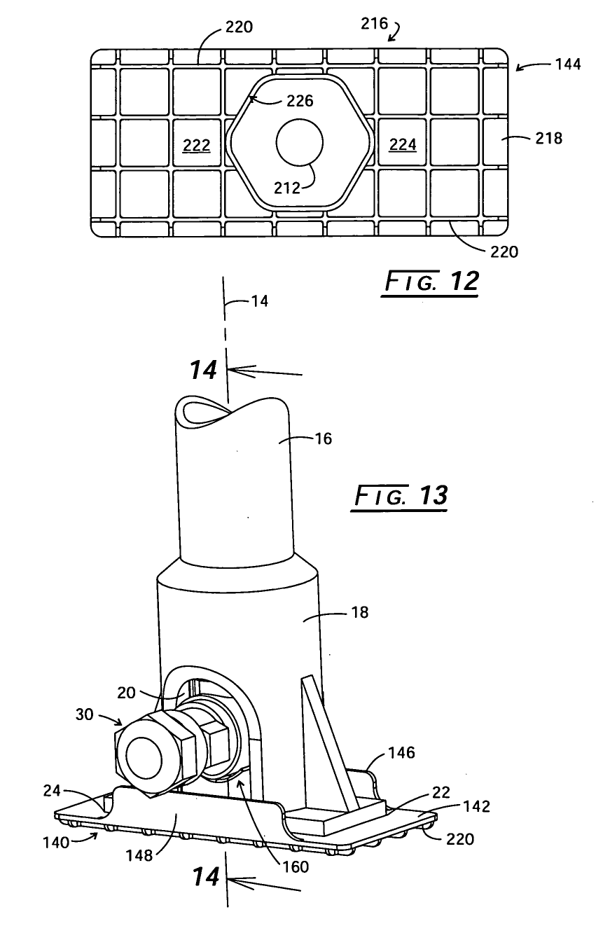

Referring to FIG. 13, an enlarged view of the curb box saddle portion 18 and lower portion 16 is illustrated in operative association with cradle 140 and the smaller version of valve 30 intended for coupling with 0.75 inch pipe. The box end surfaces of saddle portion 18 at 22 and 24 are in freely abutting engagement with corresponding bearing surfaces 156 and 158 (FIG. 11). Where valve 30 is of the larger size intended for 1 inch O. D. pipe coupling then its cylindrical surface 94 is located between the standards 200 and 202 (FIG. 11) and its stem portion is appropriately supported thereby. However, for the smaller size the smaller valve may be positioned in either direction transversely to the longitudinal base axis 154 (FIG. 11). As noted above, relative pivotal movement is permitted about axis 14 with respect to the box end surfaces 22 and 24 of saddle portion 18 and corresponding bearing surfaces 156 and 158 of receiving surface 142. Returning momentarily to FIG. 11, such relative axial rotation is limited by the stop flanges 146 and 148. For example, that limit angle is illustrated as a which is preferably about 30°.

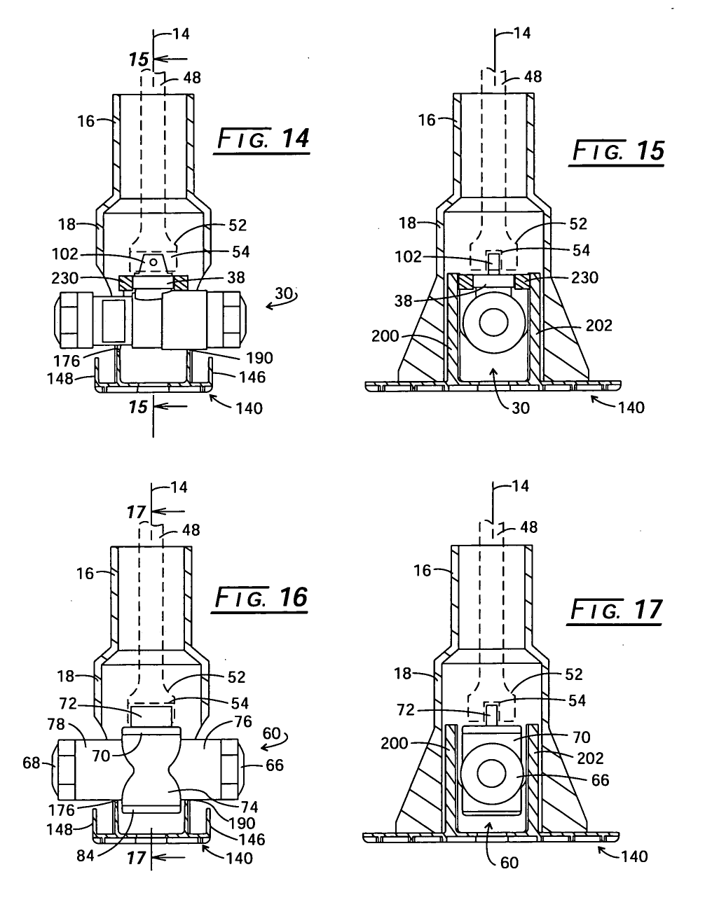

Now looking to the sectional view of FIG. 14 as identified in FIG. 13, the smaller version of valve 30 is represented as being supported within mouths 176 and 190, However, additionally provided with the cradle 140 is an annulus-shaped somewhat flexible polymeric shim 230 sometimes referred to as a “doughnut”. Shim 230 functions to mutually engage between the outer surface of stem portion 38 and the inward surfaces of standards 200 and 202, thus maintaining that stem portion in proper alignment with the axis 14 of curb box 12. Looking to the second sectional view at FIG. 15, the shim 230 is seen to be positioned in a stabilizing orientation intermediate the outer surface of stem portion 38 of valve 30 and the inward surfaces of standards 200 and 202.

Referring to FIG. 16, a similar cross section as shown in FIG. 14 is presented in conjunction with valve 60 and cradle 140. Valve 60 exhibits a symmetrical configuration in that base portion extensions 76 and 78 are essentially identically configured. Accordingly, for either of the larger versions suited for connection with 1 inch O. D. pipe or the smaller version configured for connection with 0.75 inch O.D. pipe the valve may be situated in either transverse orientation with respect to mouths 176 and 190. The larger version of the valve is represented in FIG. 16.

Looking to the second sectional view in FIG. 17, note that stem portion 70 of the valve 60 is in somewhat close adjacency with the inner surfaces of standards 200 and 202. Thus, the valve is supported for appropriate orientation with respect to axis 14. For the smaller version of the valve, a shim similar to that shown at 230 in FIGS. 14 and 15 may be employed.

The smaller version of valve 110 suited for connection with 0.75 inch O. D. pipe may be mounted in the same manner as the mounting of valve 60 described in connection with FIGS. 16 and 17. In this regard, the valve has a protrusion 132 (FIG. 6) with a hexagonal periphery 134 (FIG. 6). The outer surface spacing between parallel surfaces of the periphery 134 is about 2.125 inch. Accordingly, that hexagonal component will slidably nest within the hexagonal-shaped interior of the lower portion of valve receptor 160 (see FIG. 11). However, protrusion 132 and its associated hexagonal periphery 134 as provided with a valve 110 of a larger variety suited for coupling with 1 inch O. D. pipe will not fit within that region.

Where the larger version of valve 110 is involved, then the cradle 140 is turned upside down from its normal orientation as shown in FIGS. 18 and 19 to reveal an upwardly disposed hexagonally-shaped valve based receiving cavity 226 as described above in connection with FIG. 12. Cradle 140 having thus been positioned, stop flanges 146 and 148 as well as valve receptor 160 now are embedded within the trench bottom and valve 110 is supported from protrusion 132 as it is slidably inserted within the cavity 226. Relative movement of the entire cradle 140 is restricted by virtue of the downwardly depending components as represented at receptor 160 and flanges 146 and 148. Relative movement of the valve 110 with respect to the surface represented by the now upwardly disposed coplanar edges of the rib structure is precluded by virtue of the cavity 226. Additionally, freely abutting box end surfaces 22 and 24 may slide over the outer edges of the rib structure of base 144.

Cradle 140 may be formed of polymeric material. In this regard where the device may be employed in very rugged terrain requiring the withstanding of considerable forces and shock, then the device may be molded of a polycarbon polymer. On the other hand, it may be desirable in other terrain environments to permit an amount of flexure to the extent of partial breakage. For that arrangement, the cradle may be molded of a polymeric material provided as a co-polymer made from acrylonitrile, butadiene, and styrene, sometimes referred to as “ABS”. Alternatively, the cradle may be molded of high density polyethylene, referred to as “HDPE.”

Since certain changes may be made in the above-described apparatus without departing from the scope of the invention herein involved, it is intended that all matter contained in the description thereof or shown in the accompanying drawings shall be interpreted as illustrative and not in a limiting sense.

1. A cradle for enhancing the engagement of a curb box with a subsurface fluid valve, said curb box having an open interior generally disposed about a box axis and extending to a lower disposed saddle portion with a transverse opening extending between oppositely disposed spaced apart box end surfaces, said valve having a valve axis, a base portion, nut fittings oppositely disposed along said valve axis and generally centrally disposed stem portion, the cradle comprising:
a base having a normally upwardly disposed receiving surface extending along a longitudinal base axis with a length effective to receive said saddle portion spaced apart box end surfaces at corresponding oppositely disposed bearing surfaces;
a valve receptor extending generally normally from said base receiving surface at a location between said oppositely disposed bearing surfaces, having an upstanding receptor wall dimensioned with a length extending from said base receiving surface to a top and cross section effective for generally slideable aligning engagement within said curb box saddle portion, configured with a first valve supportive mouth arranged generally perpendicular to said longitudinal base axis, having a first mouth width, extending from said top to a first ridge generally located above said receiving surface a first ridge distance effective to form a receiving cavity, and an oppositely disposed second valve supportive mouth having a second mouth width and extending from said top to a second ridge generally located above said receiving surface a second ridge distance effective to further define said receiving cavity; and
said first and second valve supportive mouths defining with said receptor wall generally oppositely disposed elongate standards each having an interior surface.

2. The cradle of claim 1 in which:
said first mouth width is greater than said second mouth width.

3. The cradle of claim 2 in which:
said first mouth width is about 2.25 inches.

4. The cradle of claim 2 in which:
said second mouth width is about 1.875 inches.

5. The cradle of claim 1 in which:
said upstanding receptor wall length is about 3.75 inches.

6. The cradle of claim 1 in which:
said valve receptor is formed of a polymeric material which is rib reinforced.

7. The cradle of claim 6 in which:
said polymeric material exhibits a thickness of about one-eighth inch.

8. The cradle of claim 6 in which:
said polymeric material is a copolymer made from acrylonitrile, butadiene, and styrene.

9. The cradle of claim 6 in which:
said polymeric material is one or more of a polycarbonate or high density polyethylene.

10. The cradle of claim 1 in which:
said base receiving surface bearing surfaces are generally smooth to an extent effective to permit said box end surfaces to slide thereover when said curb box is relatively rotated about said box axis.

11. The cradle of claim 19 in which:
said base further comprises one or more stop flanges extending upwardly with respect to said receiving surface and positioned adjacent a bearing surface at a location limiting relative slideable rotation of said curb box about said box axis to a limit angle by abutment with said saddle portion adjacent a said box end surface.

12. The cradle of claim 11 in which:
said limit angle is about 30°.

13. The cradle of claim 1 in which:
said base further comprises a grid-like reinforcing portion disposed oppositely from said receiving surface.

14. The cradle of claim 13 in which:
said base reinforcing portion is configured to define a generally centrally disposed valve base receiving cavity having a generally hexagonal cross section dimensioned to slideably receive a hexagonally shaped downwardly depending protrusion of a valve base portion.

15. The cradle of claim 1 in which:
said valve receptor wall cross section at said receiving cavity is generally hexagonal and dimensioned to receive a downwardly depending protrusion of a valve base portion.

16. The cradle of claim 1 further comprising:
one or more generally annulus-shaped shims having an outer surface slideably engageable between the interior surfaces of said oppositely disposed elongate standards, having an interior opening configured to be positionable over a said valve stem portion at a location effective to restrict the relative rotational movement thereof about its valve axis.

17. The cradle of claim 1 in which:
said first and second ridges of respective said first and second valve supportive mouths exhibit a generally arcuate contour;

18. The cradle of claim 1 in which:
said base is configured having a water drainage opening extending therethrough at said valve receptor receiving cavity.

19. The cradle of claim 1 in which:
said valve receptor first ridge of said first valve supportive mouth extends inwardly in sloping fashion from said oppositely disposed standards and transitions therefrom as an arc extending toward said base receiving surface.

20. The cradle of claim 1 further comprising:
one or more shims having an outer surface slideably positionable between said oppositely disposed standards and having an internally disposed opening configured to be positionable over a said valve stem portion at a location effective to restrict the relative rotational movement thereof with respect to said standards.

21. A cradle for enhancing the engagement of a curb box with a subsurface fluid valve, said curb box having an open interior generally disposed about a box axis and extending to a lower disposed saddle portion with a transverse opening extending between oppositely disposed spaced apart box end surfaces, said valve having a valve axis, a base portion, nut fittings oppositely disposed along said valve axis and a generally centrally disposed stem portion, the cradle comprising:
a polymeric base having a rectangular periphery generally emulating the face periphery of a brick, having a normally upwardly disposed receiving surface disposed about a longitudinal base axis extending in perpendicular relationship between base ends and in parallel relationship with oppositely disposed base sides, and having an integrally formed grid-like reinforcing portion disposed oppositely from said receiving surface; and
a polymeric valve receptor integrally formed with said base, having a receptor wall extending from said base receiving surface intermediate said base ends about a receptor axis disposed normally to said receiving surface, said receptor wall being dimensioned with a length extending from said receiving surface to a top and a cross section effective for generally slideable aligning engagement within said curb box saddle portion when said box end surfaces are in freely abutting engagement with said base receiving surface, said receptor wall having generally U-shaped first and second valve supportive mouths arranged transversely to said base longitudinal axis having respective first and second mouth widths, extending from said top to a location defining a receiving cavity, and defining with said receptor wall oppositely disposed standards at least a portion of each of which is aligned with said base axis, said first and second mouths being configured to support any one of three or more said valves each having a unique shape in a manner wherein said valve axis is generally parallel with said base receiving surface and generally perpendicular to said base longitudinal axis.

22. The cradle of claim 21 in which:
said first mouth width is greater than said second mouth width.

23. The cradle of claim 21 in which:
said receptor wall length is about 3.75 inches; and
further comprising;
one or more shims having an outer surface slideably positionable between said oppositely disposed standards and having an internally disposed opening configured to be positionable over a said valve stem portion at a location effective to restrict the relative rotational movement thereof.

24. The cradle of claim 21 in which:
said base further comprises one or more stop flanges extending upwardly with respect to said receiving surface, being located in adjacency with a base side and extending upwardly from said receiving surface a distance effective to block relative rotation of said curb box about said box axis by abutment with said saddle portion adjacent a said box end surface.

25. The cradle of claim 21 in which:
said first mouth width is about 2.25 inches.

26. The cradle of claim 21 in which:
said second mouth width is about 1.75 inches.

27. The cradle of claim 21 in which:
said base reinforcing portion is configured to define a generally centrally disposed valve base receiving cavity having a generally hexagonal cross section dimensioned to slideably receive a hexagonally shaped downwardly depending protrusion of a valve base portion.

28. The cradle of claim 21 in which:
said valve receptor wall cross section at said receiving cavity is generally hexagonal and dimensioned to receive a downwardly depending protrusion of a valve base portion.

29. The cradle of claim 21 in which:
said first and second ridges of respective said first and second valve supportive mouths exhibit a generally arcuate contour;

30. The cradle of claim 21 in which:
said first valve supportive mouth extends from said oppositely disposed standards as arc-shaped mutually converging first ridges sloping toward said base, said first ridges transitioning to a centrally disposed arcuate second ridge.

31. The cradle of claim 30 in which:
said first ridges exhibit a radius of about 1.250 inches.

32. The cradle of claim 30 in which:
said second ridge exhibits a radius of about 0.850 inches.
